(19) United States
(12) Patent Application Publication
(10) Pub. No.: US 2011/0002831 A1
(43) Pub. Date: Jan. 6, 2011

(54) SOL-GEL PROCESS WITH AN ENCAPSULATED CATALYST

(76) Inventors: Nanning Joerg Arfsten, Aachen (DE); Pascal Jozef Paul Buskens, Heerlen (NL); Jens Christoph Thies, Eijsden (NL)

Correspondence Address: NIXON & VANDERHYE, PC, 901 NORTH GLEBE ROAD, 11TH FLOOR, ARLINGTON, VA, 22203, US

(21) Appl. No.: 12/808,014

(22) PCT Filed: Dec. 15, 2008
(86) PCT No.: PCT/EP08/67542

§ 371 Date: Sep. 14, 2010

(30) Foreign Application Priority Data
Dec. 14, 2007 (EP) 07024274.8

(51) Int. Cl. C01F 17/00; C01B 13/00; C01F 11/02; C01F 7/00; C01G 23/04; C01G 19/02; C01G 25/02; C01G 31/02; C01G 33/00; C01G 35/00; C01G 37/02; C01G 39/02; C01G 41/02; C01G 45/02; C01G 49/02; C01G 51/04; C01G 53/04; C01G 9/02; C01G 11/00

(52) U.S. Cl. 423/263; 423/593.1; 423/594.16; 423/600; 423/598; 423/594.9; 423/594.12; 423/594.8; 423/595; 423/594.13; 423/599; 423/594.1; 423/594.5; 423/594.3; 423/594.14; 423/326; 427/372.2

(57) ABSTRACT

A sol-gel process for preparing a mixture of metal-oxide-metal compounds wherein at least one metal oxide precursor is subjected to a hydrolysis treatment to obtain one or more corresponding metal oxide hydroxides, the metal oxide hydroxides so obtained are subjected to a condensation treatment to form the metal-oxide-metal compounds, which process is carried out in the presence of an encapsulated catalyst, whereby the catalytically active species is released from the encapsulating unit by exposure to an external stimulus, and wherein the catalytically active species released after exposure to such external stimulus is capable of catalyzing the condensation of the metal-hydroxide groups that are present in the metal oxide hydroxides so obtained.

The present invention relates to a sol-gel process for preparing a mixture of metal-oxide-metal compounds, a process for coating a substrate or article with said mixture, a substrate or article obtainable by said process, a process for preparing a ceramic object with said mixture and a substrate or article obtainable by said process.

Sol-gel chemistry involves a wet-chemical technique for the preparation of metal-oxide-metal compounds starting from a chemical solution which typically contains a precursor such as a metal alkoxide, a metal chloride or a metal nitrate. The precursor is usually subjected to a hydrolysis treatment and a condensation treatment to form metal-oxo or metal-hydroxo polymers in solution. The mechanism of both the hydrolysis and the condensation step are to a large extent dependent on the degree of acidity of the chemical solution.

In the case of the synthesis of polysiloxane coatings or ceramics, use can, for instance, be made of tetraalkoxysilanes as precursor materials. The sol-gel reaction can then in principle be divided into two steps:
(a) the (partial) hydrolysis of the tetraalkoxysilane monomers (1) (see Scheme 1), and
(b) the condensation of alkoxysilanes and silanols (2) to polysiloxanes (3) (see Scheme 2).

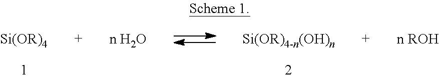

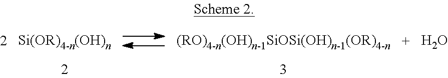

The sol-gel formulation so obtained can be used for many purposes including for instance to prepare ceramic objects or be deposited on a substrate using for example the dip coating technique. However, both the ceramic objects and the sol-gel coatings so obtained generally show an insufficient mechanical strength after drying under ambient conditions. One way to strengthen the inorganic network of the sol-gel ceramic or coating is to increase the degree of coupling in the inorganic network. For that purpose, a thermal post-condensation (curing step) is usually carried out. In case of sol-gel coatings, such a curing treatment is typically carried out at a temperature in the range of from 400 to 600° C. During the curing step further condensation is established which enhances the mechanical properties of the sol-gel coating to be obtained. In the case of ceramic objects, the post-condensation takes place during sintering at temperatures between 400° C. and 1500° C.

One disadvantage of the known sol-gel processes is that the use of a curing step, which is carried out at such an elevated temperature, restricts the range of possible applications. In this respect it is observed that most organic materials implemented in sol-gel coatings such as hydrophobising agents, typically fluoroalkyl compounds, or dyes are unstable and will decompose at high temperatures. In addition, most polymeric materials have a glass transition temperature and/or melting point below 400° C., which makes it very difficult to coat polymeric substrates or articles with a mechanically stable sol-gel film. A further disadvantage is that curing or sintering at high temperatures consumes a large amount of energy, may require special types of equipment, and can slow down a production process.

Bases, e.g. organic amines, are known to catalyze the post-condensation step of a sol-gel process and thereby allow a reduction of the curing temperature. See, for example Y. Liu, H. Chen, L. Zhang, X. Yao, Journal of Sol-Gel Science and Technology 2002, 25, 95-101 or I. Tilgner, P. Fischer, F. M. Bohnen, H. Rehage, W. F. Maier, Microporous Materials 1995, 5, 77-90. These bases are commonly added to the sol-gel formulation causing a change in the degree of acidity of the formulation. Since the stability of a sol-gel formulation is determined by the ratio of hydrolysis and condensation and both of these processes are strongly dependent on the degree of acidity, addition of bases typically causes a destabilization of the formulation and therefore a significant reduction of its lifetime.

In some cases, bases are added during the curing step. See, for example, S. Das, S. Roy, A. Patra, P. K. Biswas, Materials Letters 2003, 57, 2320-2325 or F. Bauer, U. Decker, A. Dierdorf, H. Ernst, R. Heller, H. Liebe, R. Mehnert, Progress in Organic Coatings 2005, 53, 183-190. The bases need to be gaseous at the temperature of curing and are typically purged into the curing oven. This requires the use of expensive corrosion-resistant equipment and is inconvenient for large-scale processes.

It has now been found that sol-gel coatings or ceramics can be prepared which can be cured at much lower temperatures when the sol-gel process is carried out in the presence of a particular catalyst. Surprisingly, the process of the present invention avoids one or more of the disadvantages of prior-art processes.

Accordingly, the present invention relates to a sol-gel process for preparing a mixture of metal-oxide-metal compounds wherein at least one metal oxide precursor is subjected to a hydrolysis treatment to obtain one or more corresponding metal oxide hydroxides, the metal oxide hydroxides so obtained are subjected to a condensation treatment to form the metal oxide metal compounds, which process is carried out in the presence of an encapsulated catalyst, whereby the catalytically active species is released from the encapsulating unit by exposure to an external stimulus, and wherein the catalytically active species released after exposure to such external stimulus is capable of catalyzing the condensation of the metal-hydroxide groups that are present in the metal oxide hydroxides so obtained.

The sol-gel process in accordance with the present invention enables the preparation of sol-gel coatings or ceramics which can be cured at much lower temperatures while having acceptable mechanical properties. The process of the present invention allows the catalyst to be added to the formulation without changing the ratio of hydrolysis and condensation. Hence, the bath stability is largely unaffected.

The catalyst is primarily only active when it is released from its encapsulation unit. This process is initiated through exposure to a defined external stimulus. The present process may allow for the inclusion of organic materials in the sol-gel such as hydrophobising agents or particular dyes to colour the substrate or article to be coated with the sol-gel, or to provide the sol-gel to be obtained with desired surface functionalities.

In the process in accordance with the present invention use is made of at least one metal oxide precursor, which means that use can be made of one type of metal oxide precursor or a mixture of two or more types of different metal oxide precursors.

Preferably, use is made of one type of metal oxide precursor.

The metal to be used in the metal oxide precursor can suitably be selected from magnesium, calcium, strontium, barium, borium, aluminium, gallium, indium, tallium, silicon, germanium, tin, antimony, bismuth, lanthanoids, actinoids, scandium, yttrium, titanium, zirconium, hafnium, vanadium, niobium, tantalum, chromium, molybdenum, tungsten, manganese, rhenium, iron, ruthenium, cobalt, nickel, copper, zinc and cadmium, and combinations thereof.

Preferably, the metal to be used is silicon, titanium, aluminium, zirconium and combinations thereof.

More preferably, the metal is silicon, titanium, aluminium and combinations thereof.

Suitably, the metal oxide precursor contains at least one hydrolysable group.

Preferably, the metal oxide precursor has the general formula R₁R₂R₃R₄M, wherein M represents the metal, and R₁₋₄ are independently selected from an alkyl, aryl, alkoxy, aryloxy, alkylthio, arylthio, halogen, nitro, alkylamino, arylamino, silylamino or silyloxy group.

The catalyst to be used in the present invention is encapsulated in an encapsulating unit and releases a catalytically active species upon a defined external stimulus (de-encapsulation treatment).

Preferably, the encapsulating unit is a hollow particle or a core-shell particle.

More preferably, the encapsulating unit is a core-shell particle. Still more preferably, the encapsulating unit is a polymer metal oxide core-shell particle. Most preferably, the encapsulating unit is a polymer core silica shell particle.

Preferably the core comprises a polymer selected from block copolymers and more preferably diblock and/or triblock copolymers.

In the preferred embodiment the polymer core comprises cationic polymer and more preferably cationic block copolymer.

Preferably said block copolymer comprises at least a first polymer and a second polymer which both comprise amino-based (alk) acrylate monomer units, more preferably tertiary amino-based (alk)acrylated units and most preferably tertiary aminoalkyl (alk) acrylate units. Particularly preferably said (alk)acrylate units comprise acrylate or, more particularly, methacrylate units. Other acrylate or vinyl units as are well known in the art may also be included in the polymer core composition.

In preferred embodiments, said tertiary aminoalkyl methacrylate units comprise dialkylaminoalkyl methacrylate units, especially dialkylaminoethyl methacrylate units. In a particularly preferred embodiment, said block copolymer comprises poly[2-(diisopropylamino)ethyl methacrylate)-2-(dimethylamino)ethyl methacrylate] (PDPA-PDMA).

The degree of polymerisation of the polymer is preferably controlled within specified limits. In a preferred embodiment of the invention, the degree of polymerisation of the PDPA-PDMA block copolymer is preferably controlled such that the mean degree of polymerisation of the PDPA falls in the range of 20 to 25 and the mean degree of polymerisation of the PDMA falls in the range of 65 to 70 (PDPA₂₀₋₂₅-PDMA₆₅₋₇₀), with particularly favourable results having been obtained with the PDPA₂₃-PDMA₆₈ block copolymer, wherein the subscripts denote the mean degrees of polymerisation of each block.

The catalytically active species is preferably a nucleophile, acid or base. More preferably, the catalytically active species is a base. The base can be any suitable but is preferably selected from primary, secondary or tertiary aryl- or alkylamino compounds, aryl or alkyl phosphino compounds, alkyl- or arylarsino compounds or any other suitable other compound.

Preferably, the base is an amine or phosphine, or combinations thereof.

More preferably, the base is an amine. Examples of suitable amines to be used in accordance with the present invention include primary aliphatic and aromatic amines like aniline, naphthyl amine and cyclohexyl amine, secondary aliphatic, aromatic amines or mixed amines like diphenyl amine, diethylamine and phenethyl amine and tertiary aliphatic, aromatic amines or mixed amines like triphenyl amine, triethyl amine and phenyl diethylamine and combinations thereof.

Preferably the amine is a primary or secondary amine. Most preferably the amine is an aromatic primary amine. The amine may also result from decomposition of the polymer core as a result of heat stimulus.

The mixture of metal-oxide-metal compounds (sol-gel) obtained in accordance with the present invention can suitably be subjected to a de-encapsulation treatment during which the catalytically active species is exposed and thus catalyzes the condensation of the metal-hydroxide groups that are present in the metal-oxide-metal compounds.

One major advantage of the sol-gel process of the present invention is that it enables the subsequent curing treatments to be carried out at lower temperatures. Additional advantages include the possibility to include organic materials in the sol-gel such as particular dyes to colour the substrate or article to be coated with the sol-gel, or to provide the coating to be obtained with desired surface functionalities. Examples of suitable surface functionalities include hydrophobicity and hydrophilicity. The hydrophobic functionality can, for instance, be established by means of addition of fluoroalkyl compounds. The hydrophilic functionality can be established, for instance, by means of addition of hydrophilic polymers, e.g. poly(ethylene glycol).

The de-encapsulation treatment can be carried out directly after the hydrolysis and condensation treatments. In a particular embodiment, however, the mixture of metal-oxide-metal compounds is recovered after the condensation treatment. The sol-gel coating or ceramic object so obtained can then subsequently be subjected to the de-encapsulation treatment.

An external stimulus is required to de-encapsulate the catalyst. Examples of such stimuli are a heat stimulus, ultrasonic treatment, ultra-violet irradiation, microwave irradiation, electron beaming, laser treatment, chemical treatment, X-ray irradiation, gamma irradiation, and combinations thereof. An advantage of these stimuli is that they do not require physical disturbance of a resultant coating, thus allowing for a finer finish.

Preferably, the external stimulus is selected from heat stimulus and/or ultra-violet irradiation.

Most preferably, the external stimulus is a heat stimulus.

The curing treatment can suitably be carried out at a temperature in the range of 0° C. to 450° C., preferably in the range of from 100 to 300° C., more preferably in the range of from 125 to 250° C.

Suitably, the steps preceding the curing treatment (i.e. the hydrolysis and condensation) are carried out at conditions that do not cause de-encapsulation.

In a specific embodiment, the de-encapsulation treatment is initiated by a heat stimulus during the curing treatment.

The present invention further relates to processes for preparing a sol-gel ceramic, using the sol-gel process according to the present invention. Furthermore, the present invention relates to processes for preparing a coating and coating an object, using the sol-gel process according to the present invention, wherein a coating of the mixture of metal-oxide compounds as obtained in the present sol-gel process is applied on the substrate or the article and subsequently the coating so obtained is subjected to the cleaving and curing treatment.

Hence, the present invention also relates to a substrate obtainable by the present process for coating a substrate. In addition, the present invention also relates to an article obtainable by a present process for coating an article.

### EXAMPLE

### Stage 1

### Preparation of a Polymer Core Silica Shell Particle

PDPA₂₃-PDMA₆₈ diblock copolymer was synthesised by sequential monomer addition using group transfer polymerisation according to the methods described in ‘Bütün, V.; Armes, S. P.; Billingham, N. C. Chem. Commun. 1997, 671-672’. Gel permeation chromatography analysis indicated an Mₙ of 18,000 and an M_{w}/Mₙ of 1.08 using a series of near-monodisperse poly(methyl methacrylate) calibration standards. The mean degrees of polymerisation of the PDPA and PDMA blocks were estimated to be 23 and 68, respectively, using ¹H NMR spectroscopy.

Non-crosslinked micelles of the PDPA₂₃-PDMA₆₈ diblock copolymer (degree of quaternisation=0%) were prepared by molecular dissolution at pH 2, followed by adjusting the solution pH to pH 7.2 using NaOH. Dynamic light scattering (DLS) studies at 25° C. indicated an intensity-average micelle diameter of 37 nm for a 0.25 wt. % copolymer micelle solution at pH 7.2.

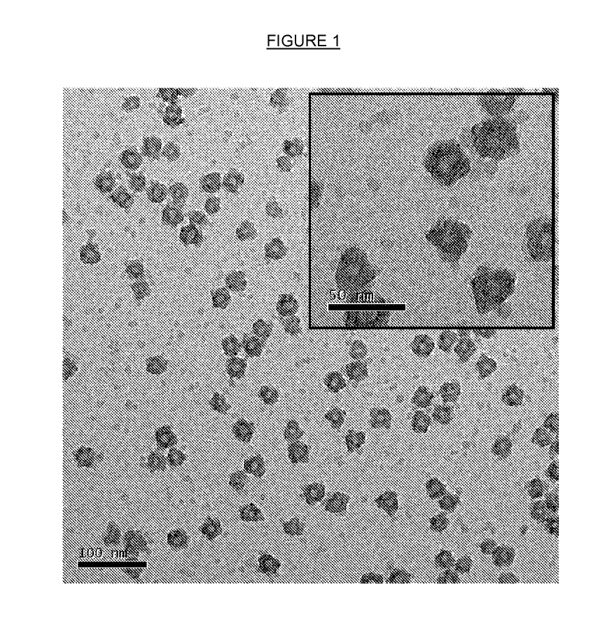

Silicification of the said micelles was achieved by mixing 2.0 ml of an aqueous micelle solution (0.25 w/v % at pH 7.2) with 1.0 ml tetramethyl orthosilicate, and then stirring the initially heterogeneous solution under ambient conditions for 20 minutes. The hybrid core-shell copolymer-silica nanoparticles thus obtained were washed with ethanol, then subjected to three centrifugation/redispersion cycles at 16,000 rpm for 5 minutes. Redispersal of the sedimented core-shell copolymer-silica nanoparticles was subsequently achieved with the aid of an ultrasonic bath. The core-shell particles are shown in the Transmission Electron Microscopy (TEM) image in FIG. 1.

### Stage 2

### Preparation of a Silica Sol-Gel System

Water (53.6 g, 12.2 wt-%) and acetic acid (5.9 g) were added to a stirred solution of tetraethoxysilane (58.4 g) in 2-propanol (159.0 g). After 24 h, the mixture was diluted with 2-propanol (160.7 g) to the desired concentration. The pH value of the resulting mixture was lowered to 1.0 by addition of concentrated nitric acid (1.3 g).

Polymer core silica shell particles prepared in stage 1 were added to the silica sol-gel system (12.5 g). Test samples were prepared by dip-coating glass substrates (2×2 cm² samples; Guardian Float Glass-Extra Clear Plus) from the resulting mixture with different amounts of core-shell particles. The samples were cured in a humid environment using following temperature program: 100° C. (0.5 h) then 150° C. (0.5 h) then 350° C. (3 h). During this process, the poly(methacrylate) core decomposes through unzipping of the polymer and the particles liberate monomers containing aminoalkyl groups. These basic compounds serve as catalytically active species catalysing the post-condensation step of the sol-gel system.

The scratch resistance of these coatings was determined using an Erichsen Hardness Test Pencil Model 318 supplied by Leuvenberg Test Techniek (Amsterdam). The results are shown in Table 1 below.

TABLE 1

| Entry | Core-shell particles [mg] | Force [N] |
|---|---|---|
| 1 | 0 | <0.1 |
| 2 | 100 | 0.3 |
| 3 | 300 | 0.7 |

### CONCLUSION

For this inorganic test system, addition of encapsulated catalyst leads to an increase of hardness by a factor 7 as compared to the system without catalyst.

1. A sol-gel process for preparing a mixture of metal-oxide-metal compounds wherein at least one metal oxide precursor is subjected to a hydrolysis treatment to obtain one or more corresponding metal oxide hydroxides, the metal oxide hydroxides so obtained are subjected to a condensation treatment to form the metal-oxide-metal compounds, which process is carried out in the presence of an encapsulated catalyst, whereby the catalytically active species is released from the encapsulating unit by exposure to an external stimulus, and wherein the catalytically active species released after exposure to such external stimulus is capable of catalyzing the condensation of the metal-hydroxide groups that are present in the metal oxide hydroxides so obtained.

2. The process according to claim 1 wherein the metal is selected from the group consisting of magnesium, calcium, strontium, barium, borium, aluminium, gallium, indium, tallium, silicon, germanium, tin, antimony, bismuth, lanthanoids, actinoids, scandium, yttrium, titanium, zirconium, hafnium, vanadium, niobium, tantalum, chromium, molybdenum, tungsten, manganese, rhenium, iron, ruthenium, cobalt, nickel, copper, zinc and cadmium.

3. The process according to claim 2 wherein the metal is silicon.

4. The process according to claim 1 wherein the metal oxide precursor has the general formula R₁R₂R₃R₄M, wherein M represents the metal, and R₁₋₄ are independently selected from alkyl, aryl, alkoxy, aryloxy, alkylthio, arylthio, halogen, nitro, alkylamino, arylamino, silylamino or silyloxy group.

5. The process according to claim 1 wherein the encapsulating unit is a hollow particle or a core-shell particle.

6. The process according to claim 1 wherein the encapsulating unit is a core-shell particle.

7. The process according to claim 6 wherein the core of the core-shell particle is a block copolymer.

8. The process according to claim 7 wherein the block copolymer comprises at least a first polymer and a second polymer which both comprise amino-based (alk)acrylate monomer groups.

9. The process according to claim 1 wherein the catalytically active species is a nucleophile, an acid or a base.

10. The process according to claim 1 wherein the catalytically active species is a base.

11. The process according to claim 1 wherein the catalytically active species is selected from primary, secondary or tertiary aryl- or alkylamino compounds, aryl or alkyl phosphino compounds, alkyl- or arylarsino compounds, and combinations thereof.

12. The process according to claim 1 wherein the external stimulus is a heat stimulus, ultra-violet irradiation, ultrasonic treatment, microwave irradiation, electron beaming, laser treatment, chemical treatment, X-ray irradiation, gamma irradiation, or combinations thereof.

13. The process according to claim 1 wherein the external stimulus is selected from heat stimulus and/or ultra-violet irradiation.

14. A process for coating a substrate or an article wherein a coating of the mixture of metal-oxide compounds as obtained in claim 1 is applied on the substrate or the article and subsequently the coating so obtained is subjected to the curing treatment.

15. A substrate or article obtainable by a process according to claim 14.

16. A process for preparing a ceramic object wherein a mixture of metal-oxide compounds as obtained in claim 1 is used to prepare a ceramic object and subsequently the object so obtained is subjected to the curing treatment.

17. An object obtainable by a process according to claim 16.
